(19) United States
(12) Patent Application Publication
(10) Pub. No.: US 2017/0285436 A1
(43) Pub. Date: Oct. 5, 2017

(54) DIFFERENTIAL PHASE BIASING MODULATOR APPARATUS AND METHOD

(71) Applicant: Coriant Advanced Technology, LLC, New York, NY (US)

(72) Inventors: Michael J. Hochberg, New York, NY (US); Matthew Akio Streshinsky, New York, NY (US); Ari Novack, New York, NY (US)

(21) Appl. No.: 14/931,875

(22) Filed: Nov. 4, 2015

(51) Int. Cl. G02F 1/225; B82Y 20/00; G02F 1/01

(52) U.S. Cl. CPC G02F 1/2257; G02F 1/0123; G02F 1/0102; B82Y 20/00; G02F 2201/126; G02F 2001/217

(57) ABSTRACT

A circuit that allows the control of a parameter in each arm of a Mach-Zehnder interferometer or modulator in push-pull mode using a single control terminal and a ground (or a differential driving circuit). The parameter that is controlled can be a phase shift, a modulation or an attenuation. The magnitude and the frequency of the parameter can be adjusted.

### FIELD OF THE INVENTION

The invention relates to signal modulation in general and particularly to a Mach-Zehnder modulator.

### BACKGROUND OF THE INVENTION

Mach-Zehnder interferometers are commonly used as modulators in integrated photonics applications. Due to the long length required of these modulators and the relatively high amount of static phase variations in the waveguides, phase tuners are needed to bias the arms of the modulator to the correct operational point. The phase tuners are often thermal phase shifters that are placed in each arm. As the complexity of the photonic circuits grow, there is a need to reduce the number of inputs to the photonic circuit.

There is a need for improved modulators for optical signal processing.

### SUMMARY OF THE INVENTION

According to one aspect, the invention features an optoelectronic device, comprising: an optical carrier having two arms: a first of the two arms having a first optical input port configured to receive a first input optical signal, and a first optical output port configured to provide a first modified optical signal; a second of the two arms having a second input optical port configured to receive a second input optical signal, and a second optical output port configured to provide a second modified optical signal; a first diode having a first polarity, the first diode configured to modify a property of the first of the two arms of the optical carrier; a second diode having a second polarity, the second diode configured to modify the property of a second of the two arms of the optical carrier; the first diode and the second diode connected in parallel connection between a first electrical terminal and a second electrical terminal, the second polarity of the second diode opposite to the first polarity of the first diode.

In some embodiments, the optoelectronic device further comprises a signal source configured to provide a time-variable electrical signal to the first electrical terminal and the second electrical terminal, the time-variable electrical signal configured to cause only one of the first diode and the second diode to attain a threshold voltage at any one time.

In one embodiment, the optoelectronic device further comprises a first and a second resistive element in series with a respective one of the first diode and the second diode.

In another embodiment, the first diode and the second diode are configured as resistive elements.

In yet another embodiment, the first diode and the second diode are configured to modify a phase shift property.

In still another embodiment, the first diode and the second diode are configured to modify at least one of a carrier concentration within the first waveguide and a carrier concentration within the second waveguide.

In yet a further embodiment, the first diode and the second diode are configured to modify an attenuation property.

In an additional embodiment, the first diode and the second diode are configured to modify a modulation property.

In still a further embodiment, the driver is configured to operate on an input optical signal having a wavelength within the range of a selected one of an O-Band, an E-band, a C-band, an L-Band, an S-Band and a U-band.

In another embodiment, the two arms are configured as a first arm and a second arm of a Mach-Zehnder interferometer, respectively.

In yet another embodiment, the driver is configured to modify a relative time skew of the first output port relative to the second output port.

In still another embodiment, the two arms are configured as the optical paths of a first optical resonator and a second optical resonator, respectively.

In a further embodiment, one of the first and the second diodes comprises silicon.

In yet a further embodiment, one of the first and the second diodes comprises germanium.

In an additional embodiment, the first and second waveguides are fabricated from a selected one of silicon, silicon nitride, SiON, InP, SiO₂, and lithium niobate.

In one more embodiment, each of the first and the second waveguides are capable of supporting one or more optical modes.

In still a further embodiment, the first input optical signal and the second input optical are the same input optical signal.

According to another aspect, the invention relates to a method of manipulating an optical signal. The method comprises the steps of: providing an optoelectronic device, comprising: an optical carrier having two arms; a first of the two arms having a first optical input port configured to receive a first input optical signal, and a first optical output port configured to provide a first modified optical signal; a second of the two arms having a second input optical port configured to receive a second input optical signal, and a second optical output port configured to provide a second modified optical signal; a first diode having a first polarity, the first diode configured to modify a property of the first of the two arms of the optical carrier; a second diode having a second polarity, the second diode configured to modify the property of a second of the two arms of the optical carrier; and the first diode and the second diode connected in parallel connection between a first electrical terminal and a second electrical terminal, the second polarity of the second diode opposite to the first polarity of the first diode; applying a time-variable electrical signal to the first electrical terminal and the second electrical terminal, the time-variable electrical signal causing only one of the first diode and the second diode to attain a threshold voltage at any one time; providing at a selected one of the first optical input port and the first optical input port a respective input optical signal; observing a modified optical signal at a respective one of the first optical output port and the second optical output port; and performing at least one of recording the modified optical signal, transmitting the modified optical signal to another apparatus, and displaying the modified optical signal to a user.

In one embodiment, the optoelectronic device further comprises a first and a second resistive element in series with a respective one of the first diode and the second diode.

In another embodiment, the optoelectronic device comprises a Mach-Zehnder interferometer.

In yet another embodiment, the modified optical signal is phase shifted relative to the input optical signal.

In still another embodiment, the modified optical signal is modulated relative to the input optical signal.

In a further embodiment, the modified optical signal is attenuated relative to the input optical signal.

In yet a further embodiment, the input optical signal has a wavelength within the range of a selected one of an O-Band, an E-band, a C-band, an L-Band, an S-Band and a U-band.

In an additional embodiment, the first input optical signal and the second input optical are the same input optical signal.

In yet another embodiment, the optoelectronic device further comprises a signal source configured to provide a time-variable electrical signal to the first electrical terminal and the second electrical terminal, the time-variable electrical signal configured to cause only one of the first diode and the second diode to attain a threshold voltage at any one time.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic diagram of a Mach-Zehnder-type interferometer having both radio-frequency driven modulator elements and electrically driven thermal shift elements.

FIG. 2 is a schematic circuit diagram of an embodiment of an electrically driven thermal push-pull phase shifter.

FIG. 3 is a graph of the current-voltage relationships in each of the arms of the circuit of FIG. 2.

FIG. 4 is a schematic diagram of a Mach-Zehnder-type interferometer having both radio-frequency driven modulator elements and electrically driven variable optical attenuator elements.

FIG. 5 is a schematic circuit diagram of a second embodiment of an electrically driven push-pull phase shifter, representing a circuit in which a variable optical attenuator (VOA) provided in each arm of a Mach-Zehnder modulator. This schematic circuit diagram may also instead represent a circuit in which a p-i-n diode in each arm of a Mach-Zehnder modulator modifies the optical signal by the charge carrier injection effect.

FIG. 6 is a graph of the current-voltage relationships in each of the parallel diodes of the circuit of FIG. 5.

FIG. 7 is a schematic diagram of a pair of optical resonators with electrically driven thermal shift elements.

FIG. 8 is a schematic diagram of a pair of tunable optical delay lines with electrical input elements.

### DETAILED DESCRIPTION

### Acronyms

A list of acronyms and their usual meanings in the present document (unless otherwise explicitly stated to denote a different thing) are presented below.

AMR Adabatic Micro-Ring

APD Avalanche Photodetector

ARM Anti-Reflection Microstructure

ASE Amplified Spontaneous Emission

BER Bit Error Rate

BOX Buried Oxide

CMOS Complementary Metal-Oxide-Semiconductor

CMP Chemical-Mechanical Planarization

DBR Distributed Bragg Reflector

DC (optics) Directional Coupler

DC (electronics) Direct Current

DCA Digital Communication Analyzer

DRC Design Rule Checking

DUT Device Under Test

ECL External Cavity Laser

FDTD Finite Difference Time Domain

FOM Figure of Merit

FSR Free Spectral Range

FWHM Full Width at Half Maximum

GaAs Gallium Arsenide

InP Indium Phosphide

LiNO₃ Lithium Niobate

LIV Light intensity(L)-Current(I)-Voltage(V)

MFD Mode Field Diameter

MPW Multi Project Wafer

NRZ Non-Return to Zero

PIC Photonic Integrated Circuits

PRBS Pseudo Random Bit Sequence

PDFA Praseodymium-Doped-Fiber-Amplifier

PSO Particle Swarm Optimization

Q Quality factor

$$Q = 2 π \frac{Energy Stored}{Energy dissipated per cycle} = 2 π {f}_{r} \frac{Energy Stored}{Power Loss} .$$

QD Quantum Dot

RSOA Reflective Semiconductor Optical Amplifier

SOI Silicon on Insulator

SEM Scanning Electron Microscope

SMSR Single-Mode Suppression Ratio

TEC Thermal Electric Cooler

WDM Wavelength Division Multiplexing

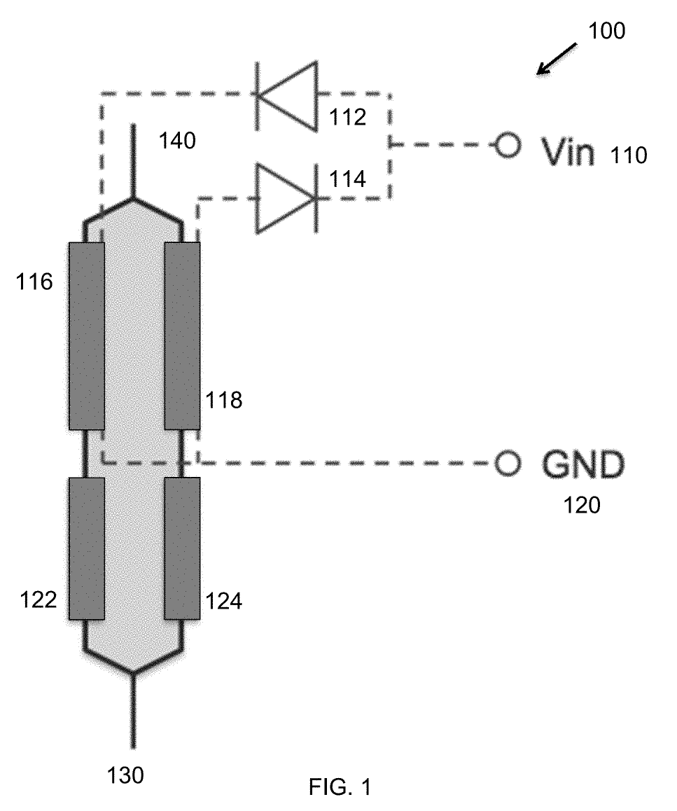

A biasing scheme in which the two arms of a Mach-Zehnder interferometer or modulator are biased such that only one arm is ever on at a given time as the two arms shift the phase in opposite directions is described. To avoid using two inputs (one for each arm), a single input can be used as shown in the circuit of FIG. 1.

FIG. 1 is a schematic diagram 100 of a Mach-Zehnder-type interferometer having both radio-frequency driven (122, 124) modulator elements and electrically driven thermal shift elements (116, 118). As illustrated in the embodiment of FIG. 1, a PN junction (diode) 112, 114 is placed in series with the resistor on each arm. The respective PN junctions face in the opposite direction (e.g., have opposite polarity) on the two arms. A voltage is then applied between to terminals Vin 110 and Ground (Gnd) 120 such that a negative bias will drive one arm and a positive bias will drive the other arm. The current flowing through the respective active diode 112, 114 flows through a respective resistive element 116, 118, which generates a thermal signal (heat). The Mach-Zehnder modulator has an input port 130 for an optical signal that is to be modulated, and an output port 140 at which the modulated signal appears.

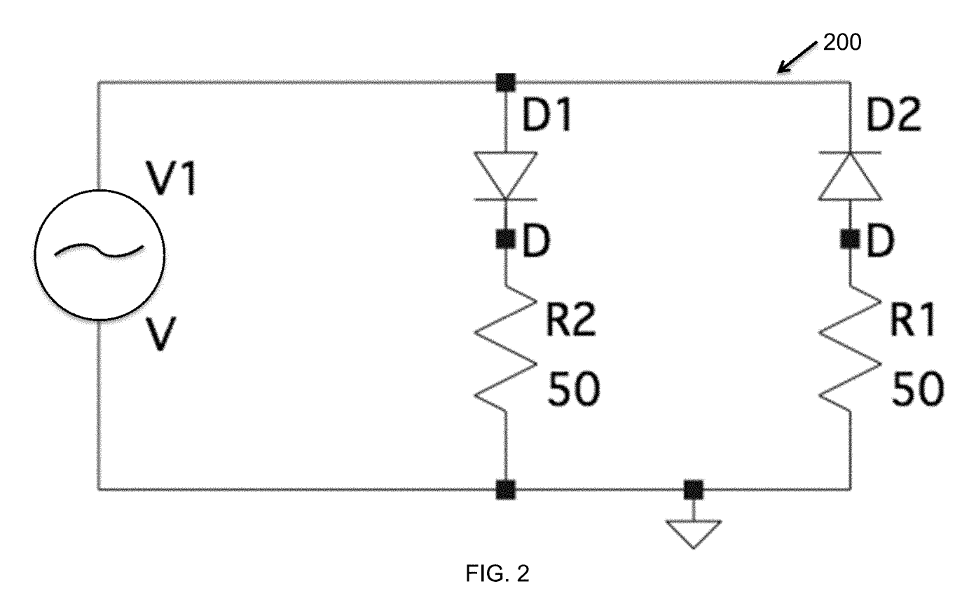

FIG. 2 is a schematic circuit diagram 200 of an equivalent circuit of an embodiment of an electrically driven thermal push-pull phase shifter. As shown in FIG. 2, a voltage V1 is applied across a diode D1 and a resistor R1 in parallel with a diode D2 and a resistor R2. In the embodiment illustrated, R1 and R2 are 50 ohm resistors. Voltage V1 is a time varying voltage, such as an alternating voltage from an AC source, a voltage generated by a square wave source, or an adjustable voltage source that provide voltage over a range of values. In some embodiments, the voltage source is programmable. In some embodiments, the voltage source is controlled by an external control circuit. When the voltage V1 has a first polarity and a magnitude that exceeds a barrier potential of the PN junction (the threshold voltage) of D1, it drives D1 and R2. When the voltage V1 has a second polarity and a magnitude that exceeds a barrier potential of the PN junction (the threshold voltage) of D2, it drives D2 and R1. This type of driving circuit will reduce the inputs needed for biasing by a factor of two, which can be significant in applications that demand a small form factor.

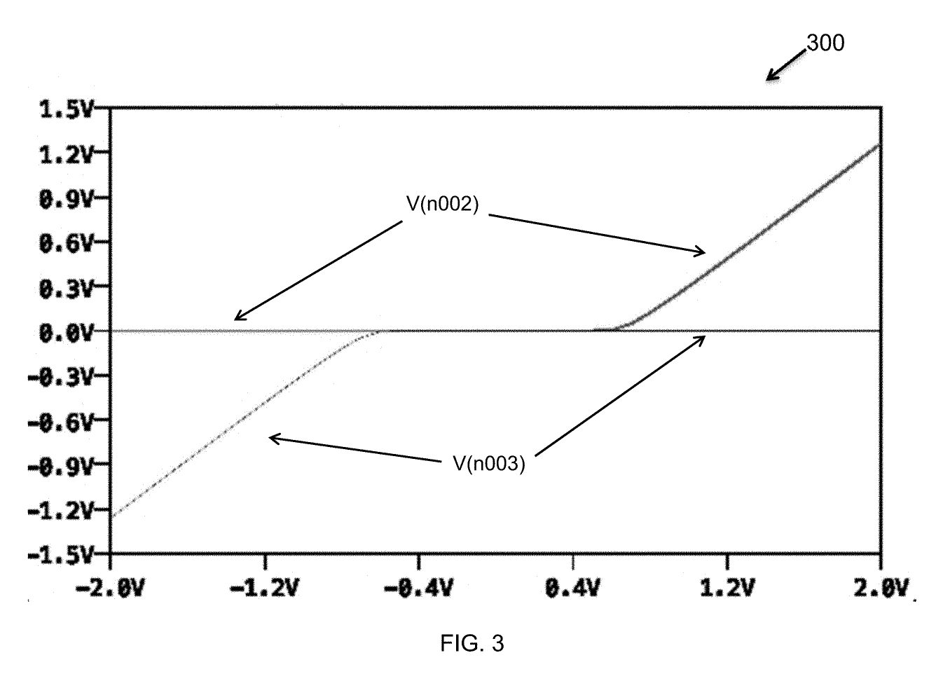

FIG. 3 is a graph 300 of the current-voltage (I-V) relationships in each of the arms of the circuit of FIG. 2. In general, the behavior of the I-V relationship will be given by the applied voltage, the Shockley ideal diode equation, and the value of the resistor.

The Shockley ideal diode equation (when n, the ideality factor, is set equal to 1) is given by:

I=I_{S}(e^{V}^{_{D}}^{/(nV}^{_{T}}⁾−1),

where I is the diode current, I_{S} is the reverse bias saturation current (or scale current), V_{D} is the voltage across the diode, V_{T} is the thermal voltage, and n is the ideality factor, also known as the quality factor or sometimes emission coefficient. The ideality factor n typically varies from 1 to 2.

As is evident from FIG. 3, the magnitude of the I-V curve, and thereby the phase shift or modulation, can be adjusted.

In different embodiments, this biasing scheme can be implemented in either a discrete or integrated manner. In the discrete case, external, discrete diodes are placed on a circuit board such that a single signal controls the two thermal shifters. In different embodiments, the diodes can be chosen such that there is a minimal voltage drop across the diode after the threshold voltage. In the integrated case, the diodes can be built into the same chip as the thermal phase shifters that they are helping to bias. Integrated photonics chips often use a PN junction for the RF phase shifter so appropriately doped regions are already available. The biasing PN junction can be located parallel to the thermal phase shifter such that very little additional area is taken on chip. The electrical connection from each biasing diode to the respective thermal phase shifter is in series as shown in the circuit diagram. A single input terminal on the photonic chip would then be sufficient to bias either thermal phase shifter. In another embodiment, the diodes integrated on the chip can be used as heater elements since there is some inherent parasitic resistance even when the diode is in the “on” state.

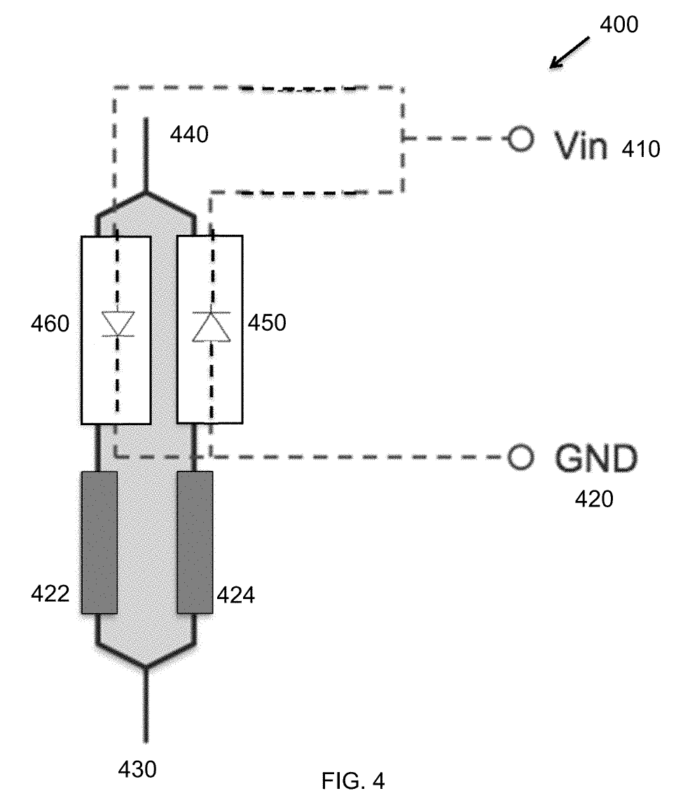

FIG. 4 is a schematic diagram 400 of a Mach-Zehnder-type interferometer having both radio-frequency driven (422, 424) modulator elements and electrically driven variable optical attenuator elements (450, 460). As illustrated in the embodiment of FIG. 4, a PN junction (diode) 450, 460 is placed in each arm. The respective PN junctions face in the opposite direction (e.g., have opposite polarity) on the two arms. A voltage is then applied between to terminals Vin 410 and Ground (Gnd) 420 such that a negative bias will drive one arm and a positive bias will drive the other arm. The current flowing through the respective active diode 450, 460 provides variable optical attenuation. The Mach-Zehnder modulator has an input port 430 for an optical signal that is to be modulated, and an output ort 440 at which the modulated signal appears.

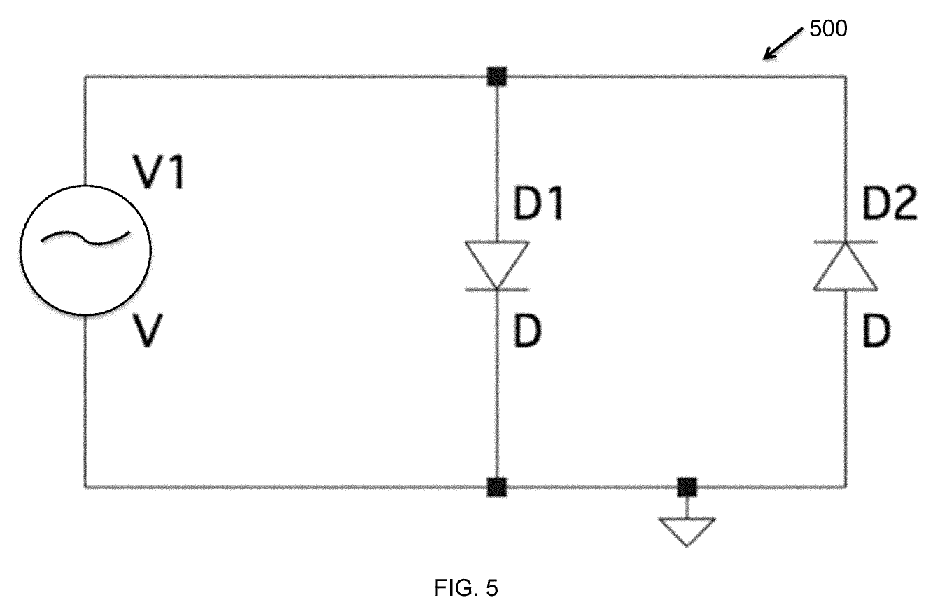

FIG. 5 is a schematic circuit diagram 500 of a second embodiment of an electrically driven push-pull phase shifter, representing a circuit in which a variable optical attenuator (VOA) or p-i-n charge carrier effect phase shifter is provided in each arm of a Mach-Zehnder modulator.

As shown in FIG. 5, a voltage V1 is applied across a diode D1 in parallel with a diode D2. Voltage V1 is a time varying voltage, such as an alternating voltage from an AC source, a voltage generated by a square wave source, or an adjustable voltage source that provide voltage over a range of values. In some embodiments, the voltage source is programmable. In some embodiments, the voltage source is controlled by an external control circuit. When the voltage V1 has a first polarity and a magnitude that exceeds a barrier potential of the PN junction (the threshold voltage) of D1, it drives D1. When the voltage V1 has a second polarity and a magnitude that exceeds a barrier potential of the PN junction (the threshold voltage) of D2, it drives D2.

In this second application, the power in the two arms of the Mach-Zehnder modulator is advantageously balanced. In this case, a respective variable optical attenuator (VOA) is used in each arm. However, only one VOA should be tuned at a given time, since the power in only one arm needs to be reduced. In the case of a PIN junction VOA, the VOA itself is the diode. Instead of adding additional components such as resistors, the circuit can be wired such that a positive voltage will activate one of the VOAs and a negative voltage will activate the other VOA directly. The resulting behavior is very similar to the thermal phase shifter case illustrated in FIG. 2 and FIG. 3, in that there is a threshold voltage at which neither VOA is on, but once the voltage is large enough in either direction, a single VOA will be activated.

As shown in FIG. 5, the diodes in the Mach-Zehnder modulator may be configured such that their primary effect is to modify the optical phase of the signal due to the charge carrier injection effect. In this third application, the relative optical phase between the two arms is varied in the same manner as described previously, in which a positive voltage will activate on diode phase shifter and a negative voltage will activate the other phase shifter.

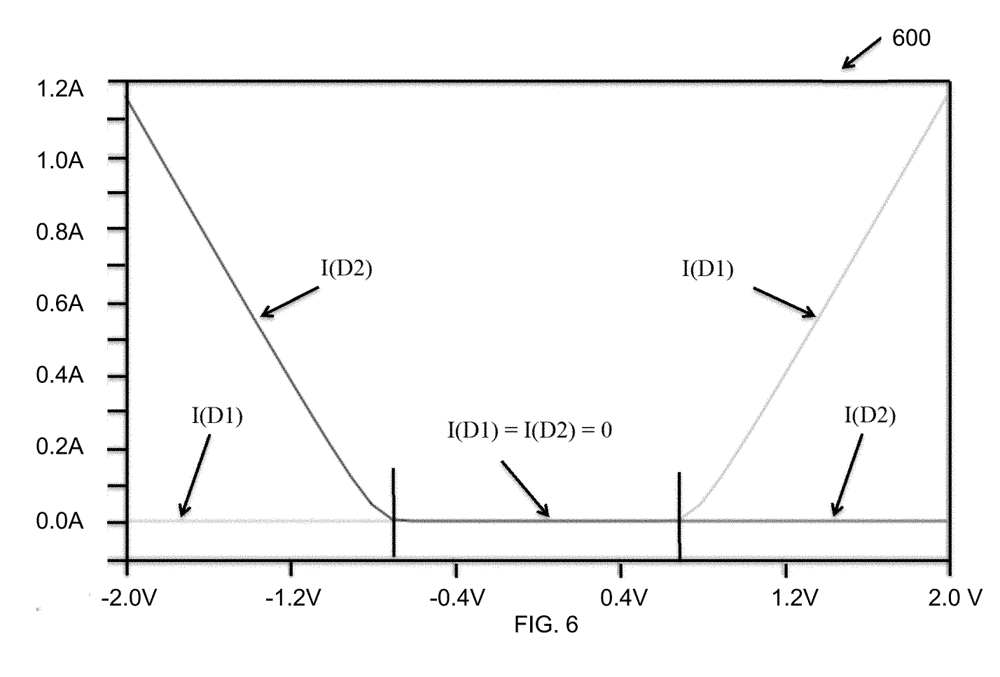

FIG. 6 is a graph 600 of the current-voltage relationships in each of the parallel diodes of the circuit of FIG. 5. As is evident from FIG. 6, the magnitude and the frequency of the I-V curve, and thereby the attenuation, can be adjusted. In some embodiments, a varying attenuation can be viewed as a modulation.

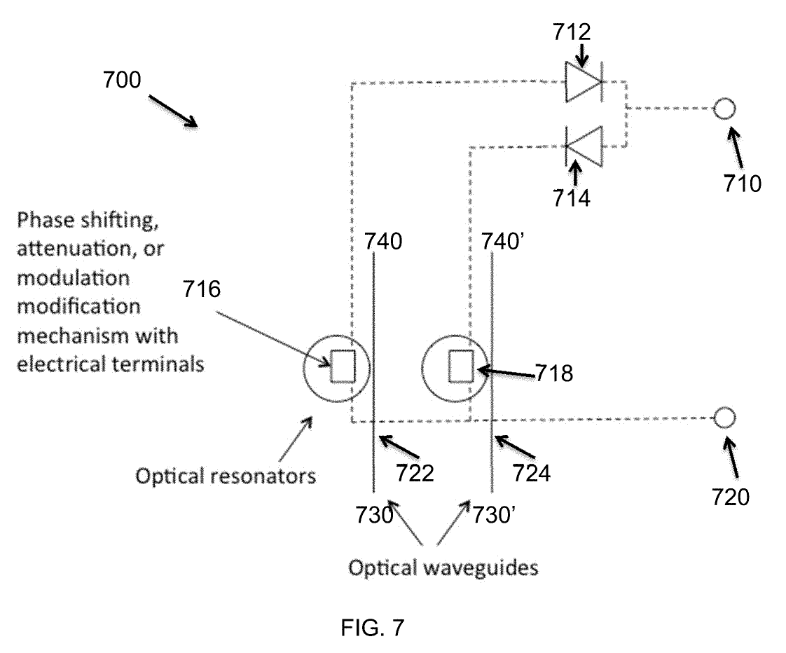

FIG. 7 is a schematic diagram 700 of a pair of optical resonators with electrically driven thermal shift elements. As illustrated in the embodiment of FIG. 7, a PN junction (diode) 712, 714 is placed in series with a resistor on each arm. The respective PN junctions face in the opposite direction (e.g., have opposite polarity) on the two arms. A voltage is then applied between to terminals 710 and (Gnd) 720 such that a negative bias will drive one arm and a positive bias will drive the other arm. The current flowing through the respective active diode 712, 714 flows through a respective resistive element 716, 718 which generates a thermal signal (heat). The ring resonators 722, 724 have input ports 730 and 730′ for optical signals that are to be filtered or modulated, and output ports 740 and 740′ at which the modified signal appears.

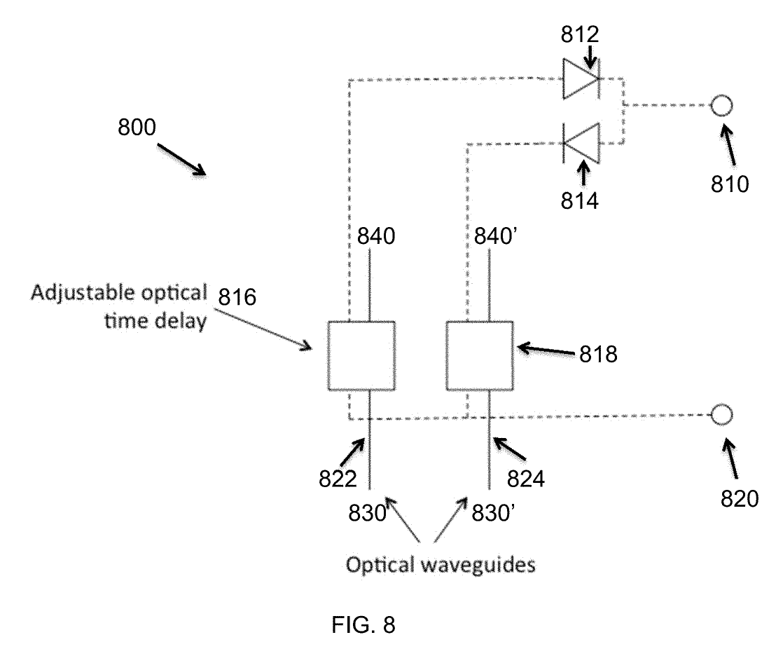

FIG. 8 is a schematic diagram 800 of a pair of tunable optical delay lines with electrical input elements. As illustrated in the embodiment of FIG. 8, a PN junction (diode) 812, 814 is placed in series with the resistor on each arm. The respective PN junctions face in the opposite direction (e.g., have opposite polarity) on the two arms. A voltage is then applied between to terminals 810 and (Gnd) 820 such that a negative bias will drive one arm and a positive bias will drive the other arm. The current flowing through the respective active diode 812, 814 flows through a respective resistive element 816, 818 which generates a thermal signal (heat). The tunable delay lines have input ports 830 and 830′ for optical signals that are to be delayed in time, and output ports 840 and 840′ at which the delayed signal appears. The time delay an optical signal experiences from input port 1 (830) to output port 1 (840) is defined here as T₁, and the time delay an optical signal experiences from input port 2 (830′) to output port 2 (840′) is defined here as T₂. The time difference by which the second optical signal is delayed relative to the first is represented by the relation:

T_{skew}=T₁−T₂

T_{skew} may be adjusted by applying a positive or negative bias to the input electrical terminal 810.

Examples of skew compensation circuits are described in co-pending U.S. patent application Ser. No. 14/931,796, filed Nov. 3, 2015, now U.S. Patent Application Publication No. _, and are believed to be suitable for use in the present invention.

In other embodiments, the driving circuit can be a differential driving circuit with a DC bias voltage.

It is believed that apparatus constructed using principles of the invention and methods that operate according to principles of the invention can be used in the wavelength ranges described in Table I.

TABLE I

| Band | Description | Wavelength Range |
|---|---|---|
| O band | original | 1260 to 1360 nm |
| E band | extended | 1360 to 1460 nm |
| S band | short wavelengths | 1460 to 1530 nm |
| C band | conventional (“erbium window”) | 1530 to 1565 nm |
| L band | long wavelengths | 1565 to 1625 nm |
| U band | ultralong wavelengths | 1625 to 1675 nm |

It is believed that in various embodiments, apparatus as previously described herein can be fabricated that are able to operate at a wavelength within the range of a selected one of an O-Band, an E-band, a C-band, an L-Band, an S-Band and a U-band.

It is believed that apparatus constructed using principles of the invention and methods that operate according to principles of the invention can be fabricated using materials systems other than silicon or silicon on insulator. Examples of materials systems that can be used include materials such as compound semiconductors fabricated from elements in Groups III and V of the Periodic Table (e.g., compound semiconductors such as GaAs, AlAs, GaN, GaP, InP, and alloys and doped compositions thereof).

### Design and Fabrication

Methods of designing and fabricating devices having elements similar to those described herein, including high index contrast silicon waveguides, are described in one or more of U.S. Pat. Nos. 7,200,308, 7,339,724, 7,424,192, 7,480,434, 7,643,714, 7,760,970, 7,894,696, 8,031,985, 8,067,724, 8,098,965, 8,203,115, 8,237,102, 8,258,476, 8,270,778, 8,280,211, 8,311,374, 8,340,486, 8,380,016, 8,390,922, 8,798,406, and 8,818,141.

### Definitions

As used herein, the term “optical communication channel” is intended to denote a single optical channel, such as light that can carry information using a specific carrier wavelength in a wavelength division multiplexed (WDM) system.

As used herein, the term “optical carrier” is intended to denote a medium or a structure through which any number of optical signals including WDM signals can propagate, which by way of example can include gases such as air, a void such as a vacuum or extraterrestrial space, and structures such as optical fibers and optical waveguides.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

### INCORPORATION BY REFERENCE

Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An optoelectronic device, comprising:
an optical carrier having two arms:
a first of said two arms having a first optical input port configured to receive a first input optical signal, and a first optical output port configured to provide a first modified optical signal;
a second of said two arms having a second input optical port configured to receive a second input optical signal, and a second optical output port configured to provide a second modified optical signal;
a first diode having a first polarity, said first diode configured to modify a property of said first of said two arms of said optical carrier;
a second diode having a second polarity, said second diode configured to modify said property of a second of said two arms of said optical carrier;
said first diode and said second diode connected in parallel connection between a first electrical terminal and a second electrical terminal, said second polarity of said second diode opposite to said first polarity of said first diode.

2. The optoelectronic device of claim 1, further comprising a signal source configured to provide a time-variable electrical signal to said first electrical terminal and said second electrical terminal, said time-variable electrical signal configured to cause only one of said first diode and said second diode to attain a threshold voltage at any one time.

3. The optoelectronic device of claim 1, further comprising a first and a second resistive element in series with a respective one of said first diode and said second diode.

4. The optoelectronic device of claim 1, wherein said first diode and said second diode are configured as resistive elements.

5. The optoelectronic device of claim 2, wherein said first diode and said second diode are configured to modify a phase shift property.

6. The optoelectronic device of claim 1, wherein said first diode and said second diode are configured to modify at least one of a carrier concentration within said first waveguide and a carrier concentration within said second waveguide.

7. The optoelectronic device of claim 5, wherein said first diode and said second diode are configured to modify a phase shift property.

8. The optoelectronic device of claim 5, wherein said first diode and said second diode are configured to modify an attenuation property.

9. The optoelectronic device of claim 1, wherein said first diode and said second diode are configured to modify a modulation property.

10. The optoelectronic device of claim 1, wherein said first diode and said second diode are configured to modify an attenuation property.

11. The optoelectronic device of claim 1, wherein said driver is configured to operate on an input optical signal having a wavelength within the range of a selected one of an O-Band, an E-band, a C-band, an L-Band, an S-Band and a U-band.

12. The optoelectronic device of claim 1, wherein said two arms are configured as a first arm and a second arm of a Mach-Zehnder interferometer, respectively.

13. The optoelectronic device of claim 1, wherein said driver is configured to modify a relative time skew of the first output port relative to the second output port.

14. The optoelectronic device of claim 1, wherein said two arms are configured as the optical paths of a first optical resonator and a second optical resonator, respectively.

15. The optoelectronic device of claim 1, wherein one of said first and said second diodes comprises silicon.

16. The optoelectronic device of claim 1, wherein one of said first and said second diodes comprises germanium.

17. The optoelectronic device of claim 1, wherein said first and second waveguides are fabricated from a selected one of silicon, silicon nitride, SiON, InP, SiO₂, and lithium niobate.

18. The optoelectronic device of claim 1, wherein each of said first and said second waveguides are capable of supporting one or more optical modes.

19. The optoelectronic device of claim 1, wherein said first input optical signal and said second input optical are the same input optical signal.

20. A method of manipulating an optical signal, comprising the steps of:
providing an optoelectronic device, comprising:
an optical carrier having two arms:
a first of said two arms having a first optical input port configured to receive a first input optical signal, and a first optical output port configured to provide a first modified optical signal;
a second of said two arms having a second input optical port configured to receive a second input optical signal, and a second optical output port configured to provide a second modified optical signal;
a first diode having a first polarity, said first diode configured to modify a property of said first of said two arms of said optical carrier;
a second diode having a second polarity, said second diode configured to modify said property of a second of said two arms of said optical carrier; and
said first diode and said second diode connected in parallel connection between a first electrical terminal and a second electrical terminal, said second polarity of said second diode opposite to said first polarity of said first diode;
applying a time-variable electrical signal to said first electrical terminal and said second electrical terminal, said time-variable electrical signal causing only one of said first diode and said second diode to attain a threshold voltage at any one time;
providing at a selected one of said first optical input port and said first optical input port a respective input optical signal;
observing a modified optical signal at a respective one of said first optical output port and said second optical output port; and
performing at least one of recording said modified optical signal, transmitting said modified optical signal to another apparatus, and displaying said modified optical signal to a user.

21. The method of manipulating an optical signal of claim 20, wherein said optoelectronic device further comprises a first and a second resistive element in series with a respective one of said first diode and said second diode.

22. The method of manipulating an optical signal of claim 20, wherein said optoelectronic device comprises a Mach-Zehnder interferometer.

23. The method of manipulating an optical signal of claim 20, wherein said modified optical signal is phase shifted relative to said input optical signal.

24. The method of manipulating an optical signal of claim 20, wherein said modified optical signal is modulated relative to said input optical signal.

25. The method of manipulating an optical signal of claim 20, wherein said modified optical signal is attenuated relative to said input optical signal.

26. The method of manipulating an optical signal of claim 20, wherein said input optical signal has a wavelength within the range of a selected one of an O-Band, an E-band, a C-band, an L-Band, an S-Band and a U-band.

27. The method of manipulating an optical signal of claim 20, wherein said first input optical signal and said second input optical are the same input optical signal.

28. The method of manipulating an optical signal of claim 20, wherein said optoelectronic device further comprises a signal source configured to provide a time-variable electrical signal to said first electrical terminal and said second electrical terminal, said time-variable electrical signal configured to cause only one of said first diode and said second diode to attain a threshold voltage at any one time.
